(19) United States
(12) Patent Application Publication
(10) Pub. No.: US 2019/0384827 A1
(43) Pub. Date: Dec. 19, 2019

(54) ITEM RECOMMENDATION METHOD AND APPARATUS, AND COMPUTER PROGRAM FOR EXECUTING THE ITEM RECOMMENDING METHOD

(71) Applicant: NAVER CORPORATION, Seongnam-si (KR)

(72) Inventors: Do Youn Kim, Seongnam-si (KR); Chun Sik KANG, Seongnam-si (KR)

(21) Appl. No.: 16/008,315

(22) Filed: Jun. 14, 2018

(51) Int. Cl. G06F 17/30

(52) U.S. Cl. CPC G06F 17/3043; G06F 3/04842; G06F 17/30952

(57) ABSTRACT

A method of providing at least one recommended item with respect to a first question of a questioner, the method including: receiving the first question from a terminal of the questioner; determining a first question and answer set corresponding to the first question, based on question similarity; determining, as a second question and answer set, a most recent question and answer set belonging to a directory corresponding to the first question; determining at least one recommended answerer corresponding to the first question, based on expertise; and providing, to the terminal of the questioner, at least one of the first question and answer set, the second question and answer set, and the at least one recommended answerer, wherein the first question and answer set and the second question and answer set each include at least one question and at least one answer.

### CROSS-REFERENCE TO RELATED APPLICATION

This application claims priority under 35 U.S.C. § 119 to Korean Patent Application No. 10-2017-0028543 filed on Mar. 6, 2017, in the Korean Intellectual Property Office, the entire contents of which are incorporated herein by reference.

### BACKGROUND

### 1. Field

One or more embodiments relate to an item recommending method, an item recommending apparatus, and a computer program for executing the item recommending method, and more particularly, to a method and apparatus for providing at least one recommended item with respect to a question of a questioner, and providing at last one recommended item with respect to an answer of an answerer, and a computer program for executing the method.

### 2. Description of the Related Art

This section provides background information related to the present disclosure which is not necessarily prior art.

With rapid developments in information and communication technology, various types of terminals, such as mobile communication terminals and personal computers (PCs), have been realized to perform various functions.

For example, a mobile communication terminal has recently been realized to perform, in addition to a basic voice communication function, various functions, such as a data communication function, an image or video capturing function by using a built-in camera, a music or video file reproducing function, a game playing function, and a broadcast watching function.

Recently, the number of users who wish to get an answer to a question that they uploaded onto a system through a terminal is increasing, and consequently, there are some problems.

In particular, since a question may be exposed to unspecified persons who are not obliged to provide an answer, a questioner frequently fails to receive a clear answer to his/her question. Also, such a question without a clear answer has a relatively low value as information due to the absence of an answer, and may even cause another questioner to be interrupted when searching for an answer.

### SUMMARY

This section provides a general summary of the inventive concept, and is not a comprehensive disclosure of its full scope or all features of the inventive concept.

One or more embodiments include a method and apparatus for providing, to a questioner, a question and answer set including similar questions, and a computer program for executing the method.

One or more embodiments include a method and apparatus for providing, to a questioner, a wide ranging question and answer set, and a computer program for executing the method.

One or more embodiments include a method and apparatus for recommending a suitable answerer to a questioner such that the questioner may get a professional and accurate answer, and a computer program for executing the method.

One or more embodiments include a method and apparatus for reducing an answer blank rate by increasing a likelihood of an answer to a question being completed, thereby increasing the number of pieces of meaningful information, and a computer program for executing the method.

One or more embodiments include a method and apparatus for causing an answerer to answer by providing a suitable question and a suitable questioner to the answerer, and accumulating meaningful question and answer sets, and a computer program for executing the method.

Additional aspects will be set forth in part in the description which follows and, in part, will be apparent from the description, or may be learned by practice of the presented embodiments.

According to one or more embodiments, a method of providing at least one recommended item with respect to a first question of a questioner, the method includes: receiving the first question from a terminal of the questioner; determining a first question and answer set corresponding to the first question, based on question similarity; determining, as a second question and answer set, a most recent question and answer set belonging to a directory corresponding to the first question; determining at least one recommended answerer corresponding to the first question, based on expertise; and providing, to the terminal of the questioner, at least one of the first question and answer set, the second question and answer set, and the at least one recommended answerer, wherein the first question and answer set and the second question and answer set each include at least one question and at least one answer.

According to one or more embodiments, a method of providing at least one recommended item with respect to a first answer of an answerer, the method includes: providing a first question to a terminal of the answerer; receiving the first answer corresponding to the first question from the terminal of the answerer; determining a third question and answer set corresponding to the first question, based on question similarity; determining, as a fourth question and answer set, a most recent question and answer set belonging to a directory corresponding to the first question; and providing, to the terminal of the answerer, at least one of the third question and answer set and the fourth question and answer set, wherein the third and fourth question and answer sets do not include an answer of any answerer.

According to one or more embodiments, an apparatus for providing at least one recommended item with respect to a first question of a questioner, the apparatus includes a controller and a memory, wherein the controller is configured to receive the first question from a terminal of the questioner, determine a first question and answer set corresponding to the first question, based on question similarity, determine, as a second question and answer set, a most recent question and answer set belonging to a directory corresponding to the first question, determine at least one recommended answerer corresponding to the first question, based on expertise, and provide, to the terminal of the questioner, at least one of the first question and answer set, the second question and answer set, and the recommended answer, wherein the first question and answer set and the second question and answer set each include at least one question and at least one answer.

According to one or more embodiments, an apparatus for providing at least one recommended item with respect to a first answer of an answerer, the apparatus includes a controller and a memory, wherein the controller is configured to provide a first question to a terminal of the answerer, receive the first answer corresponding to the first question from the terminal of the answerer, determine a third question and answer set corresponding to the first question, based on question similarity, determine, as a fourth question and answer set, a most recent question and answer set belonging to a directory corresponding to the first question, and provide, to the terminal of the answerer, at least one of the third question and answer set and the fourth question and answer set, wherein the third and fourth question and answer sets do not include an answer of any answerer.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram of an item recommending system according to an embodiment;

FIG. 2 is a block diagram of an item recommending apparatus according to an embodiment;

FIG. 3 is a flow diagram of a method by which an item recommending apparatus with respect to a questioner provides a recommended item, according to an embodiment;

FIG. 4 is a flow diagram of a method by which an item recommending apparatus with respect to an answerer provides a recommended item, according to an embodiment;

FIG. 5 illustrates an example of a screen (graphical user interface) enabling a questioner to input a question to a questioner terminal;

FIG. 6 illustrates an example of a screen (graphical user interface) in which a first question and answer set provided by a controller is displayed on a questioner terminal;

FIG. 7 illustrates an example of a screen (graphical user interface) in which a second question and answer set provided by a controller is displayed on a questioner terminal;

FIG. 8 illustrates an example of a screen (graphical user interface) in which a recommended answerer provided by a controller is displayed on a questioner terminal;

FIG. 9 illustrates an example of a screen (graphical user interface) in which a third question and answer set provided by a controller is displayed on an answerer terminal;

FIG. 10 illustrates an example of a screen (graphical user interface) in which a fourth question and answer set provided by a controller is displayed on an answerer terminal;

FIG. 11 illustrates an example of a screen (graphical user interface) in which a recommended questioner provided by a controller is displayed on an answerer terminal; and

FIG. 12 illustrates an example of screens (graphical user interfaces) in which each item is displayed in a form of a message, on a questioner terminal, according to an embodiment.

It should be noted that these figures are intended to illustrate the general characteristics of methods and/or structures utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by the example embodiments.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those of ordinary skill in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element, there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flowcharts, flow diagrams, data flow diagrams, structure diagrams, block diagrams, etc.) that may be implemented in conjunction with units and/or devices discussed in more detail below. Although discussed in a particularly manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware, software, and/or a combination thereof. For example, hardware devices may be implemented using processing circuitry such as, but not limited to, a computer processor, a central processing unit (CPU), a controller, an arithmetic logic unit (ALU), a digital signal processor, a microcomputer, a field programmable gate array (FPGA), a system-on-chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor, a CPU, a controller, an ALU, a digital signal processor, a microcomputer, a microprocessor, etc.), the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable recording media, including tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more data storage devices. The one or more storage devices may be tangible or non-transitory computer-readable storage media, such as random access memory (RAM), read only memory (ROM), a permanent mass storage device (such as a disk drive), solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such a separate computer readable storage medium may include a universal serial bus (USB) flash drive, a memory stick, a Blu-ray/DVD/CD-ROM drive, a memory card, and/or other similar computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other similar medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one of ordinary skill in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different to that of the methods described, and/or components such as the described system, architecture, devices, circuit, and the like, may be connected or combined to be different from the above-described methods, or results may be appropriately achieved by other components or equivalents.

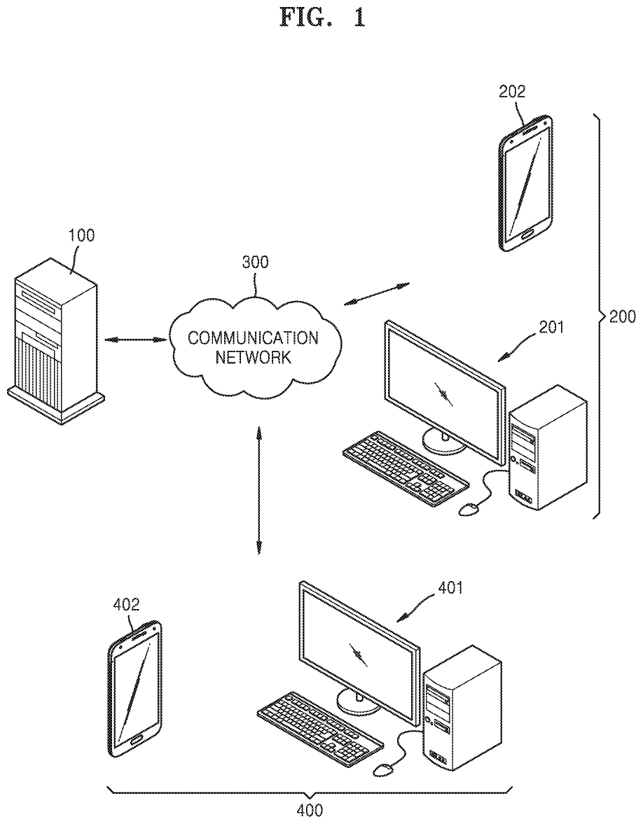

FIG. 1 is a diagram of an item recommending system according to an embodiment.

Referring to FIG. 1, the item recommending system according to an embodiment may include a server 100, a questioner terminal 200, an answerer terminal 400, and a communication network 300 connecting them.

The server 100 of the item recommending system according to an embodiment may receive a question from the questioner terminal 200, and provide a question and answer set and a recommended answerer to the questioner terminal 200 in response to the question. Also, the server 100 may receive an answer from the answer terminal 400, and provide a question and answer set and a recommended questioner to the answer terminal 400 in response to the answer. Details thereof will be described in detail later.

A question, such as a first question, may be on a subject asked by a questioner who is a user of the questioner terminal 200 on the item recommending system for obtaining an answer. Here, the question may include at least one of text, a mark or sign, voice, sound, an image, and a video, as information to be electrically transmitted or received through the communication network 300. For example, the question may be expressed via text and an image.

A question and answer set may be a data set including at least one question and/or at least one answer. For example, a question and answer set provided to the questioner terminal 200 may include a question of a questioner, an answer selected by the questioner from a pre-completed question and answer set, and an answer of an answerer to the question. Also, a question and answer set provided to the answerer terminal 400 may include only a question or only a question and an answer selected by a questioner from a pre-completed question and answer set.

Meanwhile, first through fourth question and answer sets described below are named to distinguish question and answer sets described above according to purposes and/or functions.

Meanwhile, a ‘terminal’, such as the questioner terminal 200 or the answerer terminal 400, may denote any one of various apparatuses capable of transmitting or receiving a question and/or an answer described above to or from the server 100. Here, the terminal may be a personal computer (PC) 201 or 401 or a portable terminal 202 or 402. In FIG. 1, the portable terminal 202 or 402 is illustrated as a smart phone, but is not limited thereto.

Meanwhile, the terminal may include an input unit into which a question and/or an answer are input, and a display unit displaying a question and answer set received from the server 100. Here, the input unit and the display unit may be variously configured according to forms of a question. Examples of the input unit include a keyboard, a mouse, a track ball, a microphone, a button, and a touch panel, but are not limited thereto.

The communication network 300 connects the server 100, the questioner terminal 200, and the answer terminal 400 to each other. For example, the communication network 300 provides an access path such that the questioner terminal 200 transmits or receives packet data after accessing the server 100. Examples of the communication network 300 include wired networks, such as a local area network (LAN), a wide area network (WAN), a metropolitan area network (MAN), and an integrated service digital network (ISDN), and wired networks, such as a wireless LAN, CDMA, Bluetooth, and a satellite communication network, but are not limited thereto.

The server 100 may provide, to the questioner terminal 200, a question and answer set and/or a recommended answerer corresponding to a question received from the questioner terminal 200. Also, the server 100 may provide, to the answerer terminal 400, a question and answer set and/or a recommended questioner corresponding to a question answered by an answerer. In this regard, the server 100 may include an item recommending apparatus according to an embodiment.

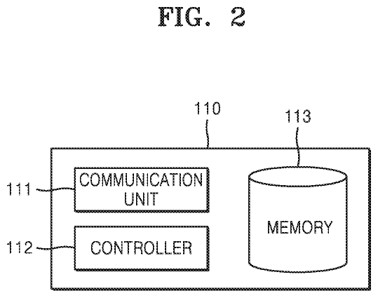

FIG. 2 is a block diagram of an item recommending apparatus 110 according to an embodiment.

Referring to FIG. 2, the item recommending apparatus 110 according to the current embodiment may include a communication unit 111, a controller 112, and a memory 113. Although not illustrated in FIG. 2, the item recommending apparatus 110 according to the current embodiment may further include an input/output unit and a program storage unit.

The communication unit 111 may be an apparatus including hardware or software required for the item recommending apparatus 110 to transmit or receive a signal, such as a control signal or a data signal, to or from another network apparatus, such as the questioner terminal 200 or the answerer terminal 400, in a wired/wireless connection manner.

The controller 112 may include any type of apparatus capable of processing data, such as a computer processor. Here, the term ‘processor’ may denote a data processing apparatus embedded in hardware and having a physically structured circuit to perform a code included in a program or a function expressed in a command. Examples of such a data processing apparatus include a microprocessor, a central processing unit (CPU), a processor core, a multiprocessor, an application-specific integrated circuit (ASIC), and a field programmable gate array (FPGA), but are not limited thereto.

The memory 113 performs a function of temporarily or permanently storing data processed by the item recommending apparatus 110. The memory 113 may include a magnetic storage medium or a flash storage medium, but is not limited thereto.

According to an embodiment, the item recommending apparatus 110 includes the server 100, but alternatively, the item recommending apparatus 110 may be provided separately from the server 100 according to function distribution.

Also, for convenience of description, the item recommending apparatus 110 will be referred to as ‘an item recommending apparatus regarding a questioner’ while describing an operation between the item recommending apparatus 110 and the questioner terminal 200, and will be referred to as ‘an item recommending apparatus regarding an answerer’ while describing an operation between the item recommending apparatus 110 and the answerer terminal 400. Accordingly, the item recommending apparatus regarding the questioner and the item recommending apparatus regarding the answerer are the same, and the item recommending apparatus 110 described above is referred to in these different ways based on its role.

<Operations of Item Recommending Apparatus Regarding Questioner>

The controller 112 according to an embodiment may receive a first question from the questioner terminal 200. Here, the first question may include a subject asked by a questioner who is a user of the questioner terminal 200. In detail, as described above, the first question may be on a subject asked by the questioner looking for an answer and may be expressed via at least one of text, a mark or a sign, voice, sound, an image, and a video. For example, the first question may include a subject to be answered in text, such as “I'm currently a wage earner and living in a rented house. Can I get a monthly rent deduction without the owner's consent?”

Also, the first question may further include, in addition to the subject to be answered, an additional subject regarding the first question. For example, the first question may further include a title and/or a topic of the first question, such as “this question is about year-end tax adjustment.” However, examples of the first question are not limited thereto.

The controller 112 according to an embodiment may match the first question received from the questioner terminal 200 to a first directory, i.e., at least one directory from among a plurality of directories. In a directory, a plurality of questions are classified according to several factors based on similarity between the questions. In other words, a directory according to an embodiment may be pre-generated and stored in the memory 113. The controller 112 according to an embodiment may match the first question to the first directory based on the content of the first question. As described above, the first question may further include additional information, such as a title, in addition to an asked subject of the questioner who is the user of the questioner terminal 200. Accordingly, the controller 112 according to an embodiment may match the first question to the first directory by referring to at least one of the additional information, such as the title, and the asked subject of the questioner, which are included in the first question.

Meanwhile, a directory may include at least one lower directory (or sub-directory) based on the extent of the directory. For example, an ‘economics’ directory may include a ‘tax, taxation’ directory as a lower directory (or sub-directory), and similarly, the ‘tax, taxation’ directory may include a ‘year-end tax adjustment’ directory as a lower directory (or sub-directory). Also, in addition to the ‘economics’ directory, there may be ‘health’, ‘living’, and ‘shopping’ directories.

The controller 112 may match the first question to an upper directory and at least one lower directory belonging to the upper directory. Also, the controller 112 may provide a directory corresponding to the first question to the questioner terminal 200.

For example, when the questioner asks a question with a title, such as “I'm currently a wage earner and living in a rented house. Can I get a monthly rent deduction without the owner's consent?”, the controller 112 may match the question to an economics directory, a ‘tax, taxation’ directory, i.e., a lower directory of the economics directory, and an year-end tax adjustment directory, i.e., a lower directory of the ‘tax, taxation’ directory, and provide such directories to the questioner terminal 200.

The questioner may determine whether the question currently input by him/herself is going to be processed according to an appropriate classification by checking the provided directories.

When the questioner determines that the directory determined by the controller 112 is wrong, the questioner may correct the directory via a correction request regarding a directory. In other words, the controller 112 according to an embodiment may receive a correction request regarding the first directory from the questioner terminal 200, and correct the first directory corresponding to the first question, in response to the correction request. The corrected first directory may be used to determine a question and answer set and a recommended answerer as described below.

The controller 112 according to an embodiment may determine a first question and answer set corresponding to the first question, based on question similarity. Here, the controller 112 may determine the first question and answer set by referring to a database.

A database may include at least one completed question and answer set. In other words, the database may pre-store at least one question and an answer to each of the at least one question. A question and answer set may be generated whenever an answer to a question of each questioner is completed. Meanwhile, the database may be configured and/or stored in the memory 113.

Herein, the term ‘question similarity’ may denote a degree of similarity between two questions. For example, question similarity may be a degree of similarity between two questions, which is expressed in a specific figure. The controller 112 may determine that two questions are similar when such a figure is equal to or higher than a threshold value.

The controller 112 according to an embodiment may determine the first question and answer set corresponding to the first question based on question similarity between the first question and a question included in the first question and answer set. Here, the controller 112 may determine the question similarity between two questions, i.e., between the first question and the question included in the first question and answer set, based on various methods.

For example, the controller 112 may determine question similarity by extracting and comparing keywords of two questions. Also, the controller 112 may determine question similarity by generating and comparing a feature vector of two questions. Also, the controller 112 may determine question similarity by collectively considering directories of two questions and tags added to the two questions.

Also, according to a selective embodiment, the controller 112 may determine question similarity based clusters of questions, the clusters derived based on keywords included in the questions and feature vectors generated from the questions. For example, the controller 112 may determine that two questions are similar when clusters of the questions match each other. Here, a cluster has a concept different from a directory, and may be changed according to a question and answer set included in a database. However, a cluster is not limited thereto.

As in the above example, when the first question is “I′m currently a wage earner and living in a rented house. Can I get a monthly rent deduction without the owner's consent?”, the controller 112 may determine, as the first question and answer set, a question and answer set including a question, such as “Do I need the owner's consent for monthly rent deduction?” or “Can I get deduction on monthly rent?”, and an answer to the question.

The controller 112 according to an embodiment may determine, as the first question and answer set, a certain number of question and answer sets in an order from highest question similarity. For example, the controller 112 may determine, as the first question and answer set, top three question and answer sets from the highest question similarity.

The first question and answer set determined as such may be provided to the questioner terminal 200, and details thereof will be provided later.

The controller 112 according to an embodiment may determine, as a second question and answer set, a most recent question and answer set belonging to a directory corresponding to the first question. Here, the ‘directory’ may be determined as described above.

The controller 112 according to an embodiment may determine, as the second question and answer set, a question and answer set to which a latest answer is added from among at least one question and answer set belonging to the first directory.

For example, when the first directory is ‘economics>tax, taxation>year-end tax adjustment’, the controller 112 may determine, as the second question and answer set, a question and answer set including a question belonging to the first directory of ‘economics>tax, taxation>year-end tax adjustment’. Here, as described above, the controller 112 may determine the question and answer set to which the ‘latest answer; is added, as the second question and answer set.

As such, the present disclosure enables a questioner to widely review various questions and answers in a field of interest, and in particular, review latest questions and answers.

In other words, by providing the first question and answer set, the present disclosure not only provides an appropriate answer to a subject asked by a questioner in a narrow range, but also provides a question and an answer related to the asked subject in a wide range. Here, by providing a latest answer, the present disclosure may reflect constantly changing public interests, thereby enabling the questioner to fundamentally gratify his/her curiosity without having to ask additional questions.

The controller 112 according to an embodiment may determine a recommended answerer corresponding to the first question, based on expertise. Here, the ‘expertise’ may denote the degree of expertise of an answerer with respect to a directory to which the first question belongs. The expertise may be determined based on, for example, the number of past answers of the answerer to a question belonging to the directory, the degree of satisfaction of a questioner regarding an answer of the answerer, and a field of answers set by the answerer him/herself.

Meanwhile, the expertise may include the degree of expertise of the answerer regarding a plurality of directories. For example, the expertise may be determined, for example, not only based on the degree of expertise of the answerer regarding the first directory to which the first question belongs, but also based on the degree of expertise of the answerer regarding second and third directories different from the first directory.

In other words, any one answerer may have expertise regarding a plurality of directories. As such, expertise may be set according to answerers and/or directories.

The controller 112 may provide at least one recommended answerer to the questioner, receive selection information with respect to a recommended answerer from the questioner terminal 200, and provide the first question to a selected recommended answerer, as will be described in detail later.

Meanwhile, as described above, the questioner may get a professional and accurate answer by providing the first and second question and answer sets and at the same time, providing a professional answerer in a field related to the first question.

The controller 112 according to an embodiment may provide, to the questioner terminal 200, at least one of the first question and answer set, the second question and answer set, the recommended answerer, and the first directory. For example, the controller 112 may provide the first directory, the first question and answer set, the second question and answer set, and the recommended answerer sequentially to the questioner terminal 200, or provide only the first question and answer set and the recommended answerer to the questioner terminal 200. However, a providing order and a provided item are not limited thereto.

Meanwhile, when the controller 112 provides the at least one recommended answerer to the questioner terminal 200, the controller 112 may receive the selection information of the questioner with respect to a recommended answerer from the questioner terminal 200. For example, the controller 112 may provide Daniel, Christine, and Thomas as recommended answerers, and the questioner terminal 200 may transmit selection information of the questioner with respect to Daniel to the controller 112.

Then, the controller 112 according to an embodiment may provide the first question to a terminal of the recommended answerer selected by the questioner, and receive an answer to the first question from the terminal of the recommended answerer. Also, the controller 112 may provide the answer of the recommended answerer to the questioner terminal 200.

When the controller 112 provides at least one first question and answer set and/or at least one second question and answer set to the questioner terminal 200, the controller 112 may receive, from the questioner terminal 200, selection information of the questioner with respect to a question and answer set. Here, the selection information may include identification (ID) information of the question and answer set selected by the questioner.

In other words, the questioner may select a desired question and an answer to the desired question from the at least one first question and answer set and/or the at least one second question and answer set. For example, the questioner may select a question most similar to the first question and an answer to the question. A question and answer set selected by the questioner may be used to determine an answer to the first question.

Then, the controller 112 according to an embodiment may determine, as the answer to the first question, an answer included in the question and answer set selected by the questioner. Also, the controller 112 may generate a new question and answer set including, as the answer to the first question, the answer included in the question and answer set selected by the questioner. Here, a ‘question’ included in the new question and answer set may include the first question. Also, the controller 112 may add the new question and answer set to the database.

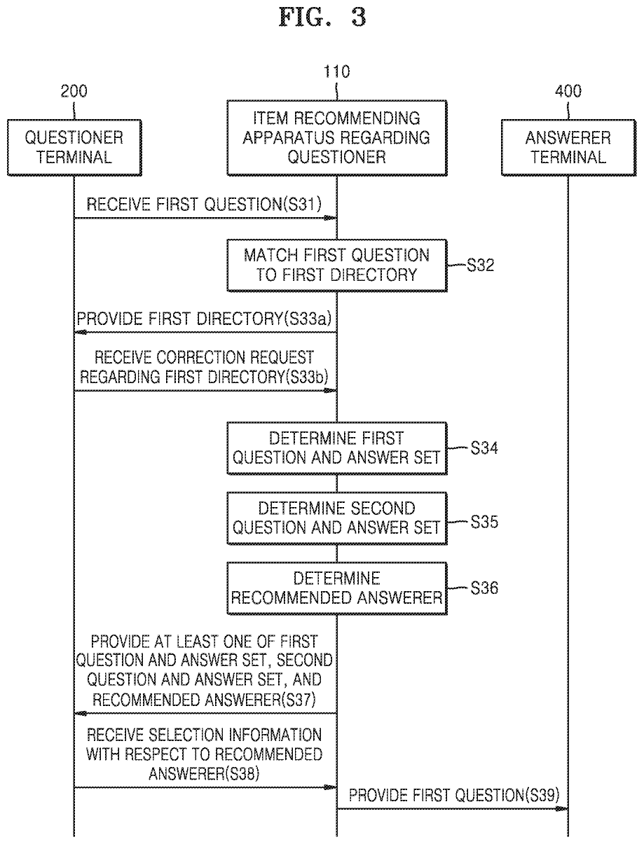

FIG. 3 is a flow diagram of a method by which the item recommending apparatus 110 with respect to a questioner provides a recommended item, according to an embodiment.

Referring to FIG. 3, the item recommending apparatus 110 according to an embodiment may receive a first question from the questioner terminal 200, in operation S31. Here, the first question may include a subject asked by the questioner who is a user of the questioner terminal 200. Also, the first question may include, in addition to a subject for an answer, additional information regarding the first question. For example, the first question may further include a title and/or a topic of a question, such as “Question about year-end tax adjustment”.

The item recommending apparatus 110 according to an embodiment may match the first question received from the questioner terminal 200 to a first directory, i.e., at least one directory from among a plurality of directories, in operation S32. For example, the item recommending apparatus 110 according to an embodiment may match the first question to the first directory, based on the content of the first question. As described above, the first question may include, in addition to a subject asked by the questioner, additional information, such as a title. Accordingly, the item recommending apparatus 110 according to an embodiment may match the first question to the first directory by referring to at least one of the additional information, such as the title, and the subject asked by the questioner included in the first question.

The item recommending apparatus 110 according to an embodiment may match the first question to an upper directory and at least one lower directory belonging to the upper directory. Also, the item recommending apparatus 110 may provide the first directory corresponding to the first question to the questioner terminal 200, in operation S33a. The questioner may identify the first directory and determine whether the first question is to be processed according to accurate classification.

When it is determined that the first directory determined by the item recommending apparatus 110 is wrong, the questioner may change the first directory via a correction request regarding the first directory. In other words, the item recommending apparatus 110 according to an embodiment may receive the correction request regarding the first directory from the questioner terminal 200 in operation S33b, and correct the first directory in response to the correction request. The first directory may be used to determine a question and answer set and a recommended answerer which will be described later.

The item recommending apparatus 110 according to an embodiment may determine a first question and answer set corresponding to the first question, based on question similarity, in operation S34. Here, the item recommending apparatus 110 may determine the first question and answer set by referring to a database. In detail, the item recommending apparatus 110 according to an embodiment may determine the first question and answer set based on question similarity between the first question and a question included in the first question and answer set. Here, the item recommending apparatus 110 may determine the question similarity between two questions, i.e., between the first question and the question included in the first question and answer set, based on various methods.

For example, the item recommending apparatus 110 may determine question similarity by extracting and comparing keywords of two questions. Also, the item recommending apparatus 110 may determine question similarity by generating and comparing a feature vector of two questions. Also, the item recommending apparatus 110 may determine question similarity by collectively considering directories of two questions and tags added to the two questions.

Also, according to a selective embodiment, the item recommending apparatus 110 may determine question similarity based on clusters of questions, the clusters derived from keywords included in the questions and feature vectors generated from the questions. For example, the item recommending apparatus 110 may determine that two questions are similar when clusters of the questions match each other. Here, a cluster has a concept different from a directory, and may be changed according to a question and answer set included in a database. However, a cluster is not limited thereto.

The item recommending apparatus 110 according to an embodiment may determine, as the first question and answer set, a certain number of question and answer sets in an order from highest question similarity. For example, the item recommending apparatus 110 may determine, as the first question and answer set, the top three question and answer sets from the highest level of question similarity.

The item recommending apparatus 110 according to an embodiment may determine, as a second question and answer set, a most recent question and answer set belonging to the first directory corresponding to the first question, in operation S35. Here, the first directory may be determined in operation S32.

For example, the item recommending apparatus 110 according to an embodiment may determine, as the second question and answer set, a question and answer set to which a latest answer is added from among at least one question and answer set belonging to the first directory. As such, the present disclosure enables a questioner to widely review various questions and answers in the field of interest, and in particular, review latest questions and answers.

In other words, by providing the first question and answer set, the present disclosure not only provides an accurate answer to a subject asked by a questioner in a narrow range, but also provides a question and an answer related to the asked subject in a wide range. Here, by providing a latest answer, the present disclosure may reflect constantly changing public interests, thereby enabling the questioner to fundamentally gratify his/her curiosity without having to ask additional questions.

The item recommending apparatus 110 according to an embodiment may determine a recommended answerer corresponding to the first question, based on expertise, in operation S36. Here, the ‘expertise’ may denote the degree of expertise of an answerer with respect to the first directory to which the first question belongs. The expertise may be determined based on, for example, the number of past answers of the answerer to a question belonging to the directory, the degree of satisfaction of a questioner regarding an answer of the answerer, and a field of answers set by the answerer him/herself.

As such, the questioner may get a professional and accurate answer by providing the first and second question and answer sets and at the same time, providing a professional answerer in a field related to the first question.

The item recommending apparatus 110 according to an embodiment may provide, to the questioner terminal 200, at least one of the first question and answer set, the second question and answer set, and the recommended answerer, in operation S37. For example, the item recommending apparatus 110 may provide the first question and answer set, the second question and answer set, and the recommended answerer sequentially to the questioner terminal 200, or provide only the first question and answer set and the recommended answerer to the questioner terminal 200. However, a providing order and a provided item are not limited thereto.

Meanwhile, when the item recommending apparatus 110 provides the at least one recommended answerer to the questioner terminal 200, the item recommending apparatus 110 may receive the selection information of the questioner with respect to a recommended answerer from the questioner terminal 200, in operation S38. For example, the item recommending apparatus 110 may provide Daniel, Christine, and Thomas as recommended answerers, and the questioner terminal 200 may transmit selection information of the questioner with respect to Daniel to the item recommending apparatus 110 (i.e., the questioner selects Daniel as the answerer, in this example).

Then, the item recommending apparatus 110 according to an embodiment may provide the first question to a terminal of the recommended answerer selected by the questioner in operation S39 (which in this example is Daniel), and receive an answer to the first question from the terminal of the recommended answerer (Daniel, in this example). Also, the item recommending apparatus 110 may provide the answer of the recommended answerer to the questioner terminal 200.

When the item recommending apparatus 110 provides at least one first question and answer set and/or at least one second question and answer set to the questioner terminal 200, the item recommending apparatus 110 may receive, from the questioner terminal 200, selection information of the questioner with respect to a question and answer set. Here, the selection information may include ID information of the question and answer set selected by the questioner.

In other words, the questioner may select a desired question and an answer to the desired question from the at least one first question and answer set and/or the at least one second question and answer set. For example, the questioner may select a question most similar to the first question and an answer to the question. A question and answer set selected by the questioner may be used to determine an answer to the first question.

Then, the item recommending apparatus 110 according to an embodiment may determine, as the answer to the first question, an answer included in the question and answer set selected by the questioner. Also, the item recommending apparatus 110 may generate a new question and answer set including, as the answer to the first question, the answer included in the question and answer set selected by the questioner. Here, a ‘question’ included in the new question and answer set may include the first question. Also, the item recommending apparatus 110 may add the new question and answer set to the database.

<Operations of Item Recommending Apparatus Regarding Answerer>

Hereinafter, the item recommending apparatus 110 is an item recommending apparatus regarding an answerer. Also, details overlapping those of FIGS. 1 through 3 will not be provided again.

The controller 112 according to an embodiment may provide a first question to the answerer terminal 400. Here, the first question may have been received from the questioner terminal 200.

Meanwhile, the controller 112 according to an embodiment may provide, to the answerer terminal 400, the first question in response to a request of the answerer terminal 400. For example, the answerer may access a system to inquire about the first question.

Meanwhile, the controller 112 may provide the first question to the answerer terminal 400 in response to a request of a questioner. For example, the questioner may assign an answerer and ask a question according to operations S38 and S39 of FIG. 3.

Then, the controller 112 according to an embodiment may receive an answer of the answerer to the first question, from the answerer terminal 400. Here, the controller 112 may add the answer of the answerer to a new question and answer set. As described above, the new question and answer set may be a question and answer set including, as the answer to the first question, an answer in a first question and answer set and/or an answer in a second question and answer set selected by the questioner.

For example, the new question and answer set may include “I'm currently a wage earner and living in a rented house. Can I get a monthly rent deduction without the owner's consent?” as a question and “Yes, it is possible without the owner's consent or a fixed date, and even a residential studio can get a deduction.” as a selected answer of the questioner.

Here, when the answerer answered “The owner's consent is not a requirement for getting the monthly rent deduction. So I guess it is possible.”, the new question and answer set may include the answer of the answerer in addition to the question and the selected answer. In other words, the new question and answer set may include one question and two answers. Here, the selected answer of the questioner and the answer of the answerer may be distinguished from each other.

Meanwhile, even when the new question and answer set does not include the selected answer, the controller 112 according to an embodiment may add the answer of the answerer to the new question and answer set. For example, when the questioner does not select a question corresponding to his/her asked subject, a question and answer set may not be complete as it does not include an answer selected by the questioner. However, at this time, an answer to the question of the questioner is still required, and thus the controller 112 may receive an answer to such an incomplete question and answer set from the answerer terminal 400, and add a received answer to the incomplete question and answer set.

The controller 112 according to an embodiment may match the first question to a first directory, i.e., at least one directory from among a plurality of directories, and since such an operation is the same as that described with reference to ‘operations of item recommending apparatus regarding questioner’, details thereof will not be provided again. Meanwhile, when a question and answer set including the first question already includes information about the first directory corresponding to the first question, the controller 112 may not perform an operation of matching the first question to the first directory.

The controller 112 according to an embodiment may determine a third question and answer set corresponding to the first question based on question similarity. Here, the controller 112 may determine the third question and answer set by referring to a database.

The third question and answer set may be a question and answer set that does not include an answer of any answerer. In other words, the third question and answer set may be a question and answer set including only the selected answer of the questioner or only the question of the questioner. Alternatively, the third question and answer set may be a question and answer set including a certain number or less of answers. However, the third question and answer set is not limited thereto.

The controller 112 according to an embodiment may determine the third question and answer set corresponding to the first question based on question similarity between the first question and a question included in the third question and answer set. Here, the controller 112 may determine the question similarity between two questions, i.e., the first question and the question included in the third question and answer set, via various methods described above.

The controller 112 according to an embodiment may determine, as the third question and answer set, a certain number of question and answer sets in an order from highest level of question similarity. For example, the controller 112 may determine, as the third question and answer set, the top three question and answer sets from the highest to lowest levels of question similarity.

The third question and answer set determined as such may be provided to the answer terminal 400, and details thereof will be provided later.

The controller 112 according to an embodiment may determine, as a fourth question and answer set, a most recent question and answer set belonging to the first directory corresponding to the first question.

The controller 112 according to an embodiment may determine, as the fourth question and answer set, a recently generated question and answer set from among at least one question and answer set belonging to the first directory. In the item recommending apparatus regarding the questioner described above, the controller 112 determines, as the second question and answer set, a question and answer set ‘to which a latest answer is added’, but in the item recommending apparatus regarding the answerer, the controller 112 determines, as the fourth question and answer set, a ‘recently generated’ question and answer set.

According to a selective embodiment, the controller 112 may determine, as the fourth question and answer set, a previously generated question and answer set from among the at least one question and answer set belonging to the first directory. However, the fourth question and answer set is not limited thereto.

Meanwhile, like the third question and answer set, the fourth question and answer set may be a question and answer set that does not include the answer of the answerer. In other words, the fourth question and answer set may be a question and answer set including only the selected answer of the questioner or only the question of the questioner. Alternatively, the fourth question and answer set may be a question and answer set including a certain number or less of answers. However, the fourth question and answer set is not limited thereto.

As such, the present disclosure provides an additional question in a field to which a question (the first question) answered by the answerer belongs, such that the questioner receives a professional answer from the answerer.

The controller 112 according to an embodiment may determine at least one recommended questioner corresponding to the first question. Generally, it is highly likely that the questioner may ask a plurality of questions regarding similar subjects, and thus the controller 112 may recommend a questioner asking at least one question belonging to the first directory corresponding to the first question to the answerer for the answerer to answer comprehensively to the first question.

Accordingly, the controller 112 may provide at least one recommended questioner to the answerer, receive selection information with respect to a recommended questioner from the answerer terminal 400, and provide at least one question of a selected recommended questioner to the answer terminal 400.

The controller 112 according to an embodiment may provide, to the answerer terminal 400, at least one of the third question and answer set, the fourth question and answer set, the recommended questioner, and the first directory.

Meanwhile, when the controller 112 provides at least one third question and answer set and/or at least one fourth question and answer set to the answerer terminal 400, the controller 112 may receive an answer of the answerer to the first question from the answerer terminal 400.

Then, the controller 112 according to an embodiment may add the answer of the answerer to a question and answer set including the first question.

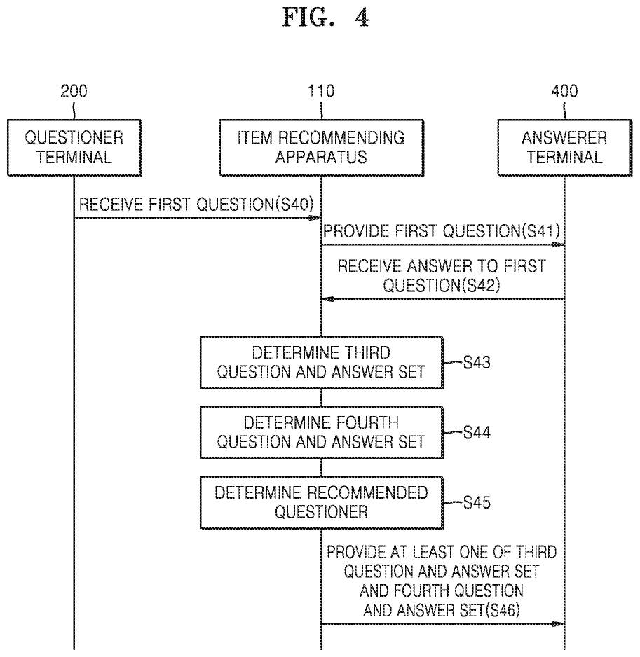

FIG. 4 is a flow diagram of a method by which the item recommending apparatus 110 regarding an answerer provides a recommended item, according to an embodiment.

Referring to FIG. 4, the item recommending apparatus 110 according to an embodiment may provide a first question to the answerer terminal 400, in operation S41. Here, the first question may have been received from the questioner terminal 200 in operation S40.

Alternatively, the item recommending apparatus 110 according to an embodiment may provide, to the answerer terminal 400, the first question in response to a request of the answerer terminal 400. For example, the answerer may access a system to inquire about the first question.

Alternatively, the item recommending apparatus 110 may provide the first question to the answerer terminal 400 in response to a request of a questioner. For example, the questioner may assign an answerer and ask a question according to operations S38 and S39 of FIG. 3.

Then, the item recommending apparatus 110 according to an embodiment may receive an answer of the answerer to the first question, from the answerer terminal 400, in operation S42. Here, the item recommending apparatus 110 may add the answer of the answerer to a new question and answer set. As described above, the new question and answer set may be a question and answer set including, as the answer to the first question, an answer in a first question and answer set and/or an answer in a second question and answer set selected by the questioner.

Meanwhile, even when the new question and answer set does not include the selected answer, the item recommending apparatus 110 according to an embodiment may add the answer of the answerer to the new question and answer set.

The item recommending apparatus 110 according to an embodiment may determine a third question and answer set corresponding to the first question based on question similarity, in operation S43. Here, the item recommending apparatus 110 may determine the third question and answer set by referring to a database.

The third question and answer set may be a question and answer set that does not include the answer of the answerer. In other words, the third question and answer set may be a question and answer set including only the selected answer of the questioner or only the question of the questioner. Alternatively, the third question and answer set may be a question and answer set including a certain number or less of answers. However, the third question and answer set is not limited thereto.

The item recommending apparatus 110 according to an embodiment may determine the third question and answer set corresponding to the first question based on question similarity between the first question and a question included in the third question and answer set. Here, the item recommending apparatus 110 may determine the question similarity between two questions, i.e., the first question and the question included in the third question and answer set, via various methods described above.

The item recommending apparatus 110 according to an embodiment may determine, as the third question and answer set, a certain number of question and answer sets in an order from highest level of question similarity. For example, the item recommending apparatus 110 may determine, as the third question and answer set, the top three question and answer sets from the highest level of question similarity.

The item recommending apparatus 110 according to an embodiment may determine, as a fourth question and answer set, a most recent question and answer set belonging to the first directory corresponding to the first question, in operation S44.

For example, the item recommending apparatus 110 according to an embodiment may determine, as the fourth question and answer set, a recently generated question and answer set from among at least one question and answer set belonging to the first directory. In the item recommending apparatus regarding the questioner described above, the item recommending apparatus 110 determines, as the second question and answer set, a question and answer set ‘to which a latest answer is added’, but in the item recommending apparatus regarding the answerer, the item recommending apparatus 110 determines, as the fourth question and answer set, a ‘recently generated’ question and answer set.

According to a selective embodiment, the item recommending apparatus 110 may determine, as the fourth question and answer set, a previously generated question and answer set from among the at least one question and answer set belonging to the first directory. However, the fourth question and answer set is not limited thereto.

Meanwhile, like the third question and answer set, the fourth question and answer set may be a question and answer set that does not include the answer of the answerer. In other words, the fourth question and answer set may be a question and answer set including only the selected answer of the questioner or only the question of the questioner. Alternatively, the fourth question and answer set may be a question and answer set including a certain number or less of answers. However, the fourth question and answer set is not limited thereto.

As such, the present disclosure provides an additional question in a field to which a question (the first question) answered by the answerer belongs, such that the questioner receives a professional answer from the answerer.

The item recommending apparatus 110 according to an embodiment may determine at least one recommended questioner corresponding to the first question, in operation S45. Generally, it is highly likely that the questioner may ask a plurality of questions regarding similar subjects, and thus the controller 112 may recommend a questioner asking at least one question belonging to the first directory corresponding to the first question to the answerer for the answerer to answer the first question comprehensively.

Accordingly, the item recommending apparatus 110 may provide at least one recommended questioner to the answerer, receive selection information with respect to a recommended questioner from the answerer terminal 400, and provide at least one question of a selected recommended questioner to the answer terminal 400.

The item recommending apparatus 110 according to an embodiment may provide, to the answerer terminal 400, at least one of the third question and answer set, the fourth question and answer set, the recommended questioner, and the first directory, in operation S46.

When the item recommending apparatus 110 provides at least one third question and answer set and/or at least one fourth question and answer set to the answerer terminal 400, the item recommending apparatus 110 may receive an answer of the answerer to the first question from the answerer terminal 400.

Then, the item recommending apparatus 110 according to an embodiment may add the answer of the answerer to a question and answer set including the first question.

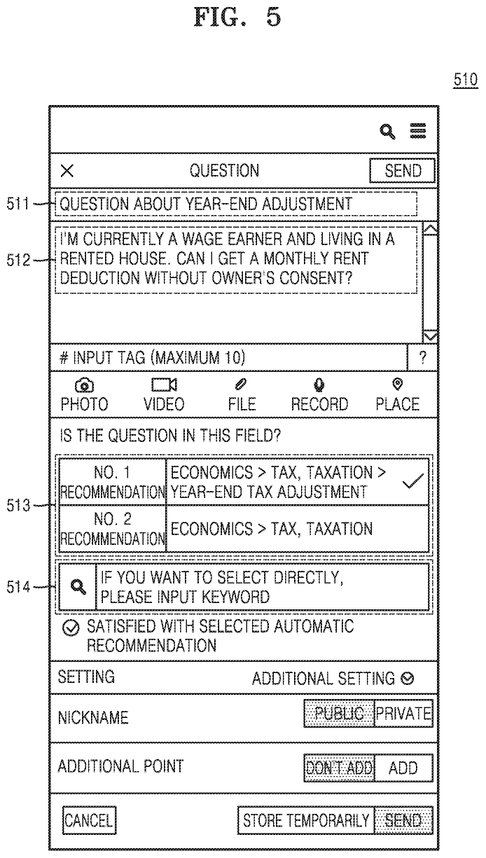

FIGS. 5 through 8 illustrate examples of screens displayed on the questioner terminal 200, according to embodiments.

FIG. 5 illustrates an example of a screen 510 enabling a questioner to input a question to the questioner terminal 200.

Referring to FIG. 5, the screen 510 may include a region 511 into which a title of a question is input, a region 512 where content of the question is input, a region 513 where a directory of the question is displayed, and a region 514 into which a keyword of the question is input.

The questioner may input the content of the question into the region 512, and in addition, input the title of the question into the region 511 and the keyword related to the question into the region 514. At this time, the title and the keyword may not be necessarily respectively input to the region 511 and the region 514. However, the title and the keyword may be used by the controller 112 to determine a question and answer set corresponding to the question.

Meanwhile the region 513 may display the directory of the question determined by the controller 112, based on the title, the content, and the keyword respectively input to the regions 511, 512, and 154. A user may determine appropriateness of items (for example, the content) input by him/herself by referring to a field of the question.

Then, the user may select a ‘send’ button on the screen 510 to transmit the question to the controller 112.

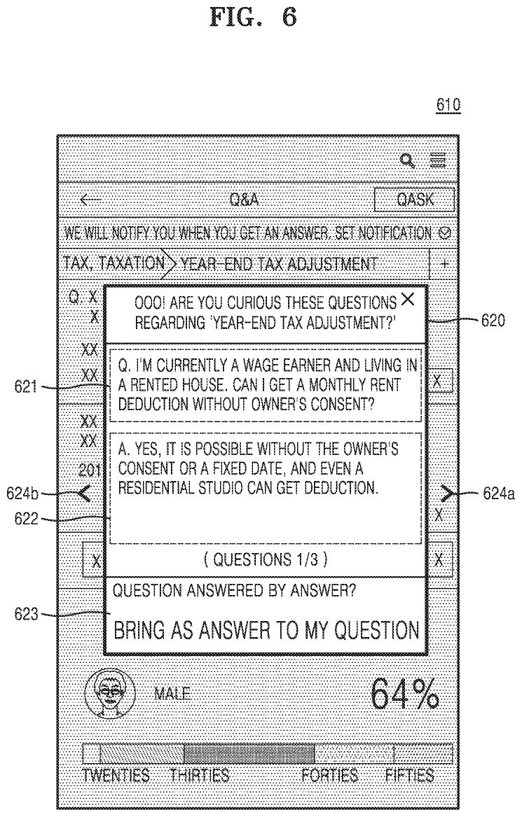

FIG. 6 illustrates an example of a screen 610 in which a first question and answer set provided by the controller 112 is displayed on the questioner terminal 200.

Referring to FIG. 6, the screen 610 may include a layer 620 where the first question and answer set is displayed, a region 621 where a question of the first question and answer set is displayed, a region 622 where an answer of the first question and answer set is displayed, a button 623 for selecting the answer of the first question and answer set as an answer to a questioner's question, and search's 624a and 624b. Here, a ‘layer’ may denote a popup window overlapping the screen 610.

The questioner may review a plurality of the first question and answer sets displayed in the regions 621 and 622 by selecting the search interface (right or left arrows) 624a or 624b. For example, the questioner may select the search interface (right arrow) 624a to review a next question, and a new first question and answer set may be displayed on the regions 621 and 622.

The questioner may finally select the button 623 to determine the answer to his/her question. In other words, the questioner may determine the answer displayed in the region 622 as the answer to his/her question by selecting the button 623.

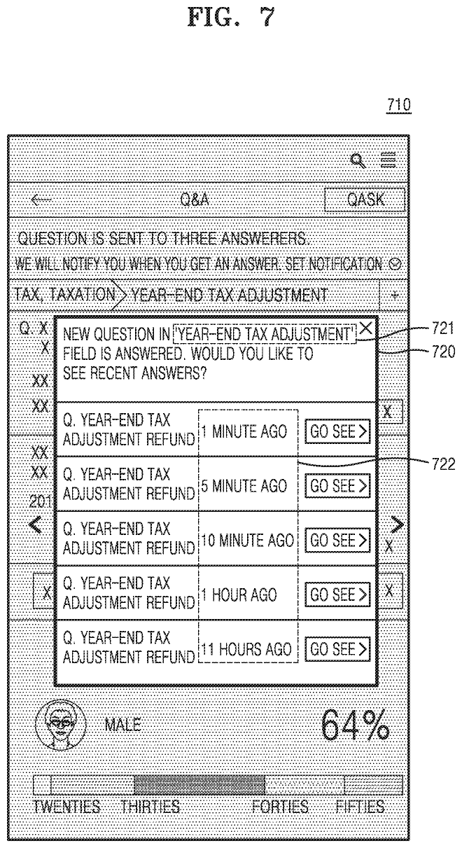

FIG. 7 illustrates an example of a screen 710 in which a second question and answer set provided by the controller 112 is displayed on the questioner terminal 200.

Referring to FIG. 7, the screen 710 may include a layer 720 where the second question and answer set is displayed, a region 721 where a directory of the second question and answer set is displayed, and a region 722 where the time periods when answers were each added to question and answer sets are displayed.

A questioner may widely review questions in the same field as his/her question by selecting and browsing any one second question and answer set by referring to the directory and the time period (or point in time) when the answer was added.

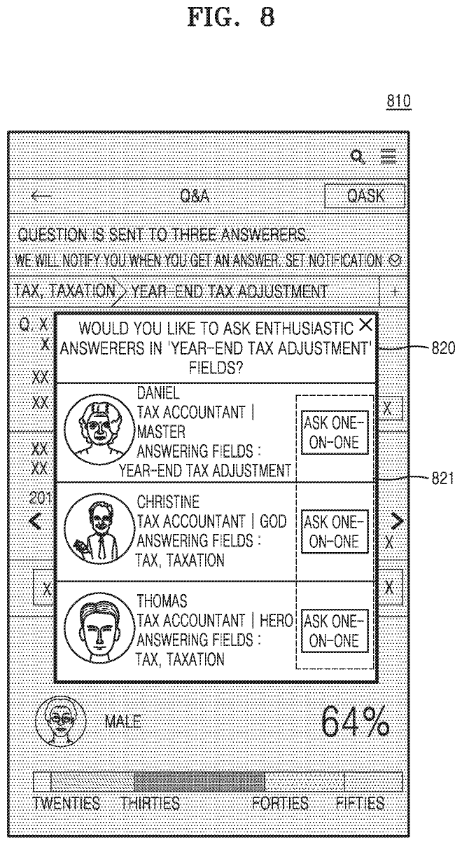

FIG. 8 illustrates an example of a screen 810 in which a recommended answerer provided by the controller 112 is displayed on the questioner terminal 200.

Referring to FIG. 8, the screen 810 may include a layer 820 where recommended answerers are displayed and a button 821 for transmitting a question to each recommended answer.

A questioner may obtain a professional answer to his/her question by transmitting the question to any one of the recommended answerers by referring to detailed information about each of the recommended answerers.

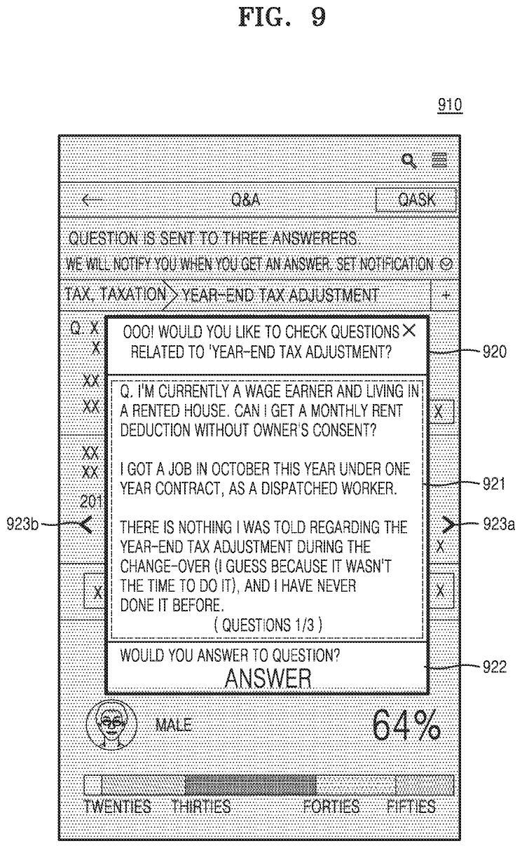

FIGS. 9 through 11 illustrate examples of screens displayed on the answerer terminal 400, according to embodiments.

FIG. 9 illustrates an example of a screen 910 in which a third question and answer set provided by the controller 112 is displayed on the answerer terminal 400.

Referring to FIG. 9, the screen 910 may include a layer 920 where the third question and answer set is displayed, a region 921 where a question of the third question and answer set is displayed, a button 922 for answering the question, and search interfaces (right and left arrows) 923a and 923b.

An answerer may review each of a plurality of third question and answer sets displayed in the region 921 by selecting the search interface (right or left arrow) 923 or 923b, and finally select the button 922 to answer a question.

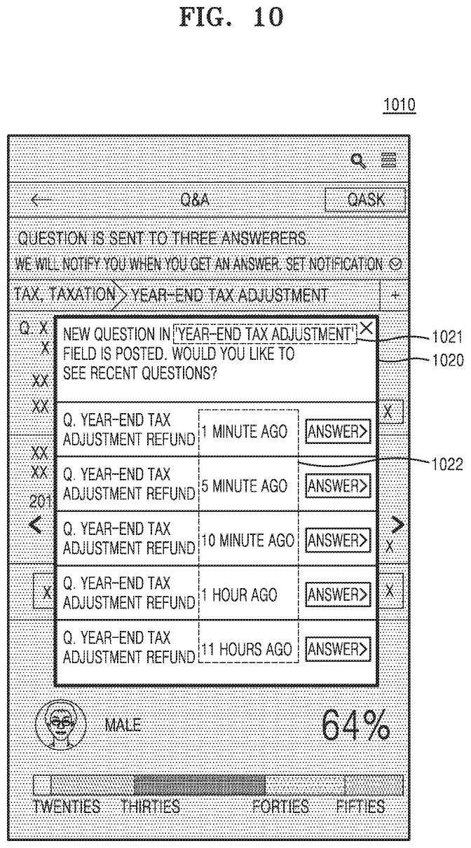

FIG. 10 illustrates an example of a screen 101 in which a fourth question and answer set provided by the controller 112 is displayed on the answerer terminal 400.

Referring to FIG. 10, the screen 1010 may include a layer 1020 where the fourth question and answer set is displayed, a region 1021 where a directory of the fourth question and answer set is displayed, and a region 1022 where time periods when the fourth question and answer sets are generated.

An answerer may select and answer any one of the fourth question and answer sets by referring to the directory and the time period (point in time) when the fourth question and answer sets were each generated.

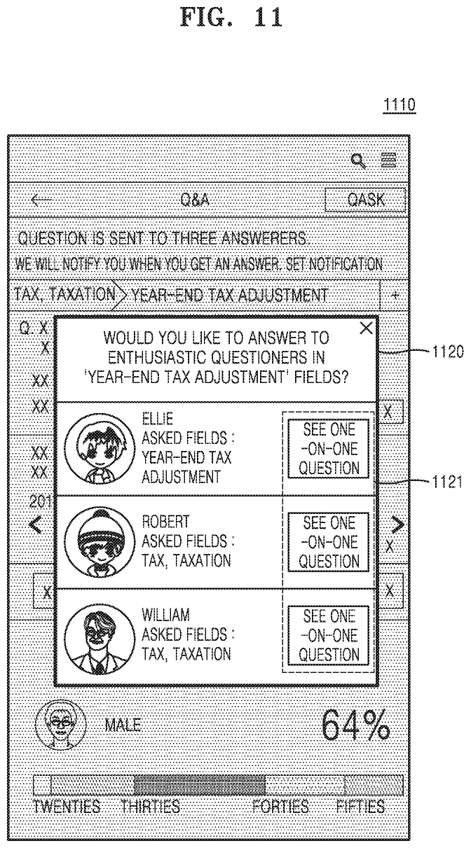

FIG. 11 illustrates an example of a screen 1110 in which a recommended questioner provided by the controller 112 is displayed on the answerer terminal 400.

Referring to FIG. 11, the screen 1110 may include a layer 1120 where recommended questioners are displayed and a button 1121 for browsing questions of each of the recommended questioners.

An answerer may browse a question of one of the recommended questioners and provide an answer to the question, by referring to detailed information of the recommended questioners.

In FIGS. 5 through 11, each item according to an item recommending method according to an embodiment is provided in a form of a webpage, but is not limited thereto.

For example, each item according to an item recommending method according to another embodiment may be provided to a questioner and an answerer in a form of a message, or aside from such a visual form, may be provided in any form recognizable by a user, such as sound or vibration.

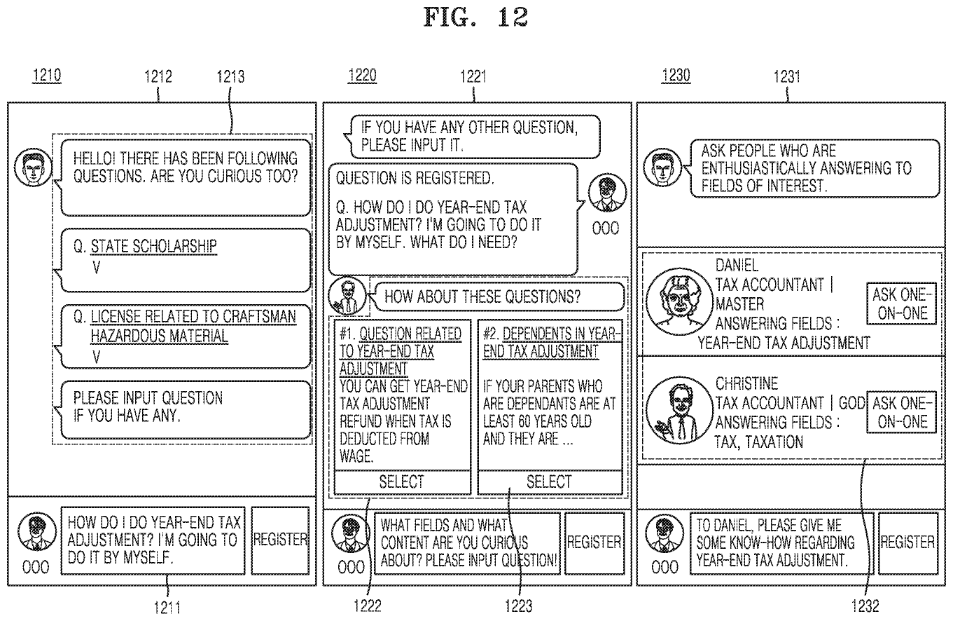

FIG. 12 illustrates an example of screens 1210 through 1230 in which each item is displayed in a form of a message, on the questioner terminal 200, according to an embodiment.

First, the screen 1210 may include a region 1211 where a questioner inputs a question and a region 1212 where a chat history is displayed.

The questioner may input a question in a form of conversation into the region 1211 to send the question to the controller 112.

Meanwhile, the region 1212 where the chat history is displayed regardless of whether a question of the questioner is input and/or there is an asked subject, may include a region 1213 where a question (or questions) of another questioner is displayed. For example, the controller 112 may display a question having the highest number of hits in the region 1213, but an embodiment is not limited thereto.

Meanwhile, according to another embodiment, the controller 112 may receive certain information from the questioner terminal 200 and display a question determined based on the certain information, in the region 1213. Here, the certain information may include a history of the questioner checking other questions and/or a search history of the questioner, but is not limited thereto.

Then, the screen 1220 may include a region 1221 where a chat history is displayed.

Here, the region 1221 may include a region 1222 where a first question and answer set determined by the controller 112 is displayed.

The questioner may browse a question and answer set by selecting one of selection buttons 1223 of the question and answer sets displayed in the region 1222.

The screen 1230 may include a region 1231 where a chat history is displayed.

Here, the region 1231 may include a region (not shown) where a question of the questioner is displayed, a region (not shown) where the first question and answer set determined by the controller 112 is displayed, and a region 1232 where recommended answers are displayed.

The questioner may select one of the recommended answerers displayed in the region 1232 and transmit the question to the selected recommended answerer.

According to one or more embodiments, several question and answer sets including similar questions may be provided to a questioner, and the questioner may select a most appropriate question and answer set from among the several question and answer sets such that the questioner may get accurate and fast answer without getting help from others.

Also, according to one or more embodiments, a questioner may widely review various question and answer sets in the field of interest, and in particular, review latest questions and answers.

Also, according to one or more embodiments, an accurate answer to a subject asked by a questioner may be provided in a narrow range, and a question and an answer related to the asked subject may be provided in a wide range.

Also, according to one or more embodiments, by providing a latest answer, constantly changing public interests may be reflected, and thus a questioner may fundamentally gratify his/her curiosity without having to ask additional questions.

Also, according to one or more embodiments, an answer blank rate may be reduced by increasing a likelihood of completing an answer to a question, thereby increasing the number of pieces of meaningful information.

Also, according to one or more embodiments, an answerer is caused to answer by providing a suitable question and a suitable questioner to the answerer, thereby accumulating meaningful question and answer sets.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be modified in various ways. Such modifications are not to be regarded as a departure from the disclosure, and all such modifications are intended to be included within the scope of the disclosure.

What is claimed is:

1. A method of providing at least one recommended item with respect to a first question of a questioner, the method comprising:
receiving the first question from a terminal of the questioner;
determining a first question and answer set corresponding to the first question, based on question similarity;
determining, as a second question and answer set, a most recent question and answer set belonging to a directory corresponding to the first question;
determining at least one recommended answerer corresponding to the first question, based on expertise; and
providing, to the terminal of the questioner, at least one of the first question and answer set, the second question and answer set, and the at least one recommended answerer,
wherein the first question and answer set and the second question and answer set each comprise at least one question and at least one answer.

2. The method of claim 1, wherein the determining of the first question and answer set comprises determining, as the first question and answer set, at least one question and answer set comprising a question corresponding to the first question, based on the question similarity.

3. The method of claim 1, further comprising matching the first question to a first directory that is at least one directory from among a plurality of directories,
wherein, in the plurality of directories, a plurality of questions are classified according to several factors based on similarity between the plurality of questions.

4. The method of claim 3, wherein the determining as the second question and answer set comprises determining, as the second question and answer set, a question and answer set to which a latest answer is added from among at least one question and answer set belonging to the first directory.

5. The method of claim 3, wherein the matching comprises matching the first question to the first directory based on content of the first question.

6. The method of claim 3, wherein the providing comprises providing the first directory to the terminal of the questioner in addition to providing the at least one of the first question and answer set, the second question and answer set, and the at least one recommended answerer.

7. The method of claim 1, wherein the providing comprises providing at least one recommended answerer to the terminal of the questioner, and
the method further comprises, after the providing, receiving selection information of the questioner with respect to the at least one recommended answerer, from the terminal of the questioner.

8. The method of claim 7, further comprising, after the receiving of the selection information:
providing the first question to a terminal of a recommended answerer selected by the questioner from among the at least one recommended answerer;
receiving an answer of the selected recommended answerer to the first question from the terminal of the at least one recommended answerer; and
providing the answer of the selected recommended answerer to the terminal of the questioner.

9. A method of providing at least one recommended item with respect to a first answer of an answerer, the method comprising:
providing a first question to a terminal of the answerer;
receiving the first answer corresponding to the first question from the terminal of the answerer;
determining a third question and answer set corresponding to the first question, based on question similarity;
determining, as a fourth question and answer set, a most recent question and answer set belonging to a directory corresponding to the first question; and
providing, to the terminal of the answerer, at least one of the third question and answer set and the fourth question and answer set,
wherein the third and fourth question and answer sets do not include an answer of any answerer.

10. The method of claim 9, wherein the determining of the third question and answer set comprises determining, as the third question and answer set, at least one question and answer set comprising a question corresponding to the first question, based on the question similarity.

11. The method of claim 9, further comprising matching the first question to a first directory that is at least one directory from among a plurality of directories,
wherein, in the plurality of directories, a plurality of questions are classified according to several factors based on similarity between the plurality of questions.

12. The method of claim 11, wherein the determining of the fourth question and answer set comprises determining, as the fourth question and answer set, a question and answer set that was recently generated from among at least one question and answer set belonging to the first directory.

13. The method of claim 11, wherein the matching comprises matching the first question to the first directory based on content of the first question.

14. The method of claim 11, wherein the providing comprises providing the first directory to the terminal of the answerer in addition to providing the at least one of the third question and answer set and the fourth question and answer set.

15. The method of claim 9, further comprising determining at least one recommended questioner corresponding to the first question,
wherein the providing comprises providing the recommended questioner to the terminal of the answerer, and
the method further comprises, after the providing, receiving selection information of the answerer with respect to the recommended questioner, from the terminal of the answerer.

16. The method of claim 15, further comprising, after the receiving of the selection information:
providing at least one question of the recommended questioner selected by the answerer to the terminal of the answerer.

17. A non-transitory computer-readable recording medium storing a computer program for providing at least one recommended item with respect to a first question of a questioner, the computer program when executed by a computer performing the steps comprising:
receiving the first question from a terminal of the questioner;
determining a first question and answer set corresponding to the first question, based on question similarity;
determining, as a second question and answer set, a most recent question and answer set belonging to a directory corresponding to the first question;
determining at least one recommended answerer corresponding to the first question, based on expertise; and
providing, to the terminal of the questioner, at least one of the first question and answer set, the second question and answer set, and the at least one recommended answerer,
wherein the first question and answer set and the second question and answer set each comprise at least one question and at least one answer.
